(19) United States
(12) Patent Application Publication
(10) Pub. No.: US 2007/0266959 A1
(43) Pub. Date: Nov. 22, 2007

(54) METHOD AND APPARATUS FOR MONITORING AN ANIMAL IN REAL TIME

(76) Inventor: Tom J. Brooks, Stephenville, TX (US)

Correspondence Address: LAW OFFICE OF STEVEN B. LEAVITT, L.L.P., P.O. BOX 537, ROWLETT, TX, 75030-0537, US

(21) Appl. No.: 11/383,955

(22) Filed: May 17, 2006

(51) Int. Cl. A01K 15/02

(52) U.S. Cl. 119/720

(57) ABSTRACT

An animal mounted camera system for remotely monitoring and transmitting data from an animal in its natural habitat. The system comprises a camera, microphone, battery pack, antenna, microprocessor, housing, solar cell/battery blanket, and a data transmission unit. The camera and microphone provide an analog signal output and transmits the signal to the data transmission unit. Via the antenna, the data transmission unit transmits the audio and video analog signal to a UHF antenna array. The transmitted signal is actual footage of an animal in its natural habitat. In one embodiment, the system can monitor temperature, heart rate, respiratory rate, location using a global positioning system (GPS) or some other tracking system, and other systems for collecting data relating to a subject animal and how the animal behaves in its natural environment, free of human influences.

### BACKGROUND OF THE INVENTION

1. Technical Field

The invention relates to the field of animal research, behavioral study, analysis, management. More specifically, the invention relates to a system and method for tracking and monitoring animal activity and habits, particularly for ruminant animals such as deer.

2. Description of Related Art

Current knowledge of animal behavior has been obtained from dedicated and meticulous firsthand observation. Behavioral studies are often difficult and complicated because the subject animals are moving targets that often hide in forests or underbrush and many are active only at night.

The difficulties of studying free-ranging animals are further compounded when climate and geography are considered. Additionally, many animals have evolved extraordinary sensory capabilities that keep them keenly attuned to the slightest disturbance to the natural equilibrium of their living environment. However, the natural equilibrium is often disturbed because, in order to observe and understand animals in their natural state, scientists need to get close to them.

Unfortunately, the scent of a human being, the rustling pages of a notebook, or the sound of a voice whispering into a tape recorder can easily disturb an animal's natural attention and actions thereby affecting the integrity of the research into the animal's behavior. What is needed is a way to closely monitor an animal's behavior while minimizing the influence that such monitoring may have and, more preferably, without causing any appreciable influence upon the behavior of the animal.

Technology has assisted in helping biologists overcome some of the above mentioned problems especially over the last three decades. Small radio and satellite transmission systems have been used to help keep researchers connected to their subjects from a distance. Radio collars and satellite transmitters have been deployed on a wide variety of animals to study their movement patterns free of human influence. Research has shown that subject animals can carry telemetry packages with virtually no impact on natural behavior. Deployed on animals, the instruments can relay information on location and movement patterns of animals. The work has yielded valuable data on home ranges, migratory routes, and temporal activity patterns. However, these devices cannot tell biologists what an animal is actually doing at a given location and time.

What is needed is a system that is capable of broadcasting live images from the perspective of an animal and would provide real-time data on habitat usage, foraging strategies, social interactions, and other pertinent activities that could help elucidate a more complete and compelling record of the animal's behavior. It would be beneficial if the system would allow scientists to see and measure how species allocate time and why. It would also be beneficial if a permanent audio/video record could be made of events, enabling scientists to review animal behavior by systematically, or even statistically, scrutinizing events frame-by-frame, if necessary, to achieve a new appreciation and understanding of animal biology and behavior.

The system should be a small, light, and efficient video telemetry package able to transmit high quality video, audio, and data over considerable distances for extended periods of time. Further, the system should provide a live, uninterrupted data-stream from an animal's point of view that is free of human influences that would otherwise have a harmful affect on monitoring the animal's natural behavior.

### SUMMARY OF INVENTION

The present invention solves the above-described problem by providing an animal mounted camera system for remotely monitoring and transmitting data from an animal in its natural habitat. The system comprises a camera, microphone, battery pack, antenna, microprocessor, housing, solar cell/battery blanket, and a data transmission unit. The camera is preferably a low voltage color bullet camera and is located in the housing along with the microprocessor and microphone. In another embodiment, an infra red (IR) camera is used in conjunction with the color camera. Preferably, the IR camera is also a low voltage bullet-type camera and is located in the housing or as a single camera unit capable of both daytime color transmission and low-light IR.

The solar/battery pack is attached to the animal and powers the camera(s), microphone, microprocessor, data transmission unit, and any other electronic equipment in the system. The battery pack contains at least one rechargeable battery. The solar cell blanket is secured to the animal's back and is capable of recharging the at least one battery in the battery pack. Preferably, at least one battery is a series of batteries.

In one embodiment, the antenna is located in the housing and at least a portion of the antenna extends from the housing. In another embodiment, the antenna is contained entirely within the housing.

The system is secured to the subject animal with a securing device such as, but not limited to, a collar, harness, blanket, or other device capable of securing the system to an animal. The securing device is designed for the specific animal, or type of animal, to be monitored. Particularly, a system may be used on a ruminant animal such as a deer whereby the camera may be secured between antlers using adhesive and connected to a Some design considerations regarding the harness include habitat, size of the animal, the amount of weight that the animal can carry without significantly affecting its mobility or habits, typical animal activity, and the like.

The low voltage camera(s) and microphone provide an analog or digital signal output and transmits the signal to the data transmission unit. Via the antenna, the data transmission unit transmits the audio and video analog or digital signal to an UHF antenna array. The transmitted analog signal received by the UHF antenna is actual footage of an animal in its natural habitat and is uploaded to live streaming media via the Internet, used to produce various still images for print media for publication, and/or for storage on CD, DVD, and VHS tape and other media used for storing visual data.

In one embodiment, the system can monitor temperature, heart rate, respiratory rate, location using a global positioning system (GPS) or some other tracking system, and other systems for collecting data relating to a subject animal and how the animal behaves in its natural environment, free of human influences.

In one embodiment, the data transmission unit transmits a signal at a frequency of about 450 mhz. By transmitting at this frequency, the data transmission unit is power efficient while maintaining a desirable range. A receiver may be positioned to receive transmissions from the data transmission unit. If the receiver is out of the effective range of the data transmission unit, at least one repeater may be used to receive and retransmit a signal from the data transmission unit.

In one embodiment, more than one receiver may be used to receive the transmissions from the data transmission unit. When more than one receiver is used, after the signal is received by a receiver, the signal is transmitted to a receiving station where the signal is compared with the signal sent by the other receivers. Then the receiving station determines what receiver received the best signal from the data transmission unit and that best received signal is transmitted over a LAN, WAN, the Internet, or some other network.

Other features and advantages of the present invention will become apparent upon reading the following detailed description of embodiments of the invention, when taken in conjunction with the appended claims.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a block diagram in accordance with an embodiment of the present invention;

FIG. 2 is a perspective view of an animal (deer in this instance) with the system attached in accordance with an embodiment of the present invention;

FIG. 3 is a perspective view of the camera in accordance with an embodiment of the present invention;

FIG. 4 is a cross sectional front view of the battery pack in accordance with an embodiment of the present invention;

FIG. 5 is a top view of the solar blanket in accordance with an embodiment of the present invention;

FIG. 6 is a diagram of one embodiment depicting the direct transmission of data in accordance with an embodiment of the present invention;

FIG. 7 is a diagram of one embodiment depicting the transmission of data using a repeater in accordance with an embodiment of the present invention; and

FIG. 8 is a diagram of one embodiment depicting the transmission of data to multiple towers in accordance with an embodiment of the present invention.

### DETAILED DESCRIPTION OF THE INVENTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

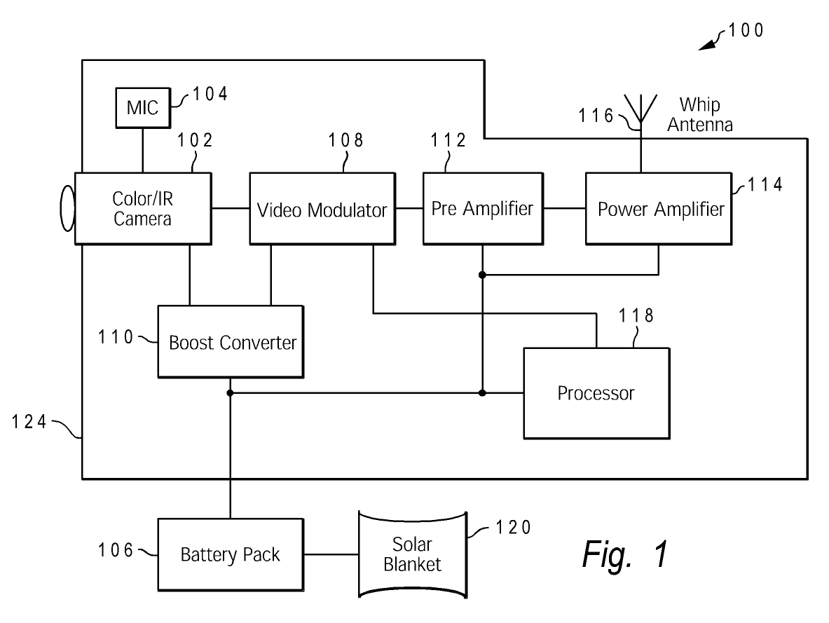

Referring to FIG. 1, shown is a block diagram of an animal mounted camera system 100 for remotely monitoring and transmitting data from an animal in its natural habitat wherein the animal mounted camera system comprises at least one camera 102, at least one microphone 104, battery pack 106, video modulator 108, boost converter 110, pre-amplifier 112, power amplifier 114, antenna 116, microprocessor 118, solar blanket 120, and housing 124. The system is attached to the subject animal, preferably when the animal is sedated or tranquilized.

All electrical components of the system are powered by battery pack 106. Battery pack 106 contains at least one battery 402, shown in FIG. 4. Preferably at least one battery 402 is a rechargeable battery and more preferably is a lithium ion rechargeable battery with about a 6.1 Ah capacity, 3 to 4.2 V voltage range, is relatively light weight, has little or no memory effect, and can operate in temperatures from about −20° C. to about 60° C. An example of a suitable battery for use in a preferred embodiment includes, but is not limited to the Ultralife battery model UBBL07 manufactured by Ultralife Batteries, Inc. located in Newark, N.Y. If at least one battery 104 is a rechargeable battery, then the rechargeable battery is capable of being recharged by solar blanket 120.

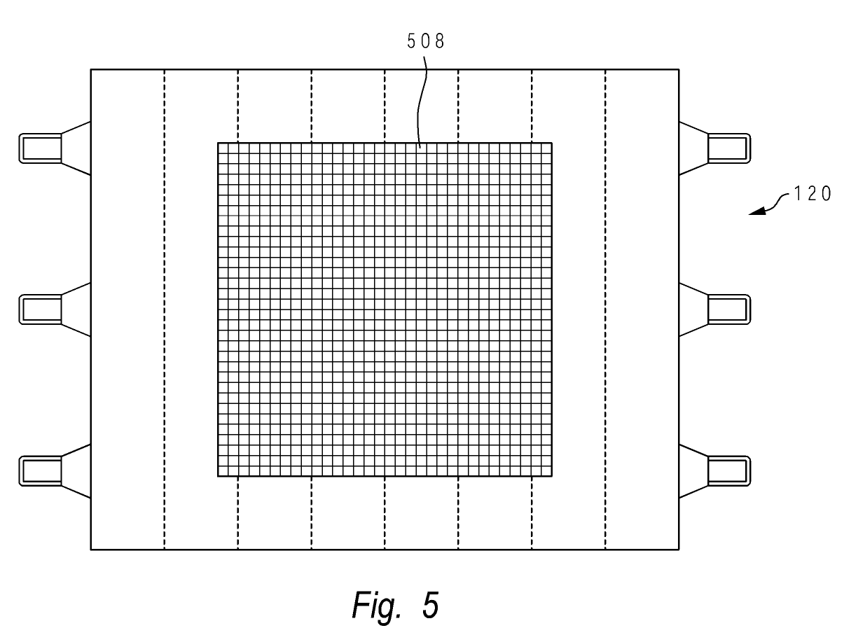

As shown in FIG. 5, at least a portion of solar blanket 120 is comprised of at least one solar cell 508 as is known in the art. The number of solar cells in solar blanket 120 depends on the required voltage for the system and the size of the animal wearing solar blanket 120. Preferably solar blanket 120 contains 32 solar cells 508 connected in series wherein each cell is about 2 inches by about 2 inches and has an open circuit voltage of about 0.5 VDC for each cell and a short circuit current of about 600-800 mA based on light intensity. When sunlight intensity is sufficient, the solar blanket 120 is capable of simultaneously powering the electronics and charging the battery pack. The required sunlight intensity depends on the number and kind of solar cell used in solar blanket 120 and such use is known in the art.

In one embodiment, a series diode between solar blanket 120 and battery pack 106 is used to prevent reverse leakage current when the voltage produced by solar blanket 120 is insufficient to charge battery pack 106. In another embodiment, a series power field effect transistor (FET) is used to prevent overcharging of battery pack 106. In use, the microprocessor 118 continuously monitors the voltage of battery pack 106 and if the voltage is below the minimum voltage threshold of the system, then the FET is switched on to allowing charging. Alternatively, if the voltage of battery pack 106 is above the minimum voltage threshold of the system, then the FET is switched off to prevent overcharge.

As shown in FIG. 1, battery pack 106 is connected to at least one camera 102, at least one microphone 104, video modulator 108, boost converter 110, pre-amplifier 112, power amplifier 114, antenna 116, microprocessor 118, and solar blanket 120 via an electrical connection. Preferably, the electrical connection from solar blanket 120 to battery pack 106 and from battery pack 106 to housing 124 is contained within a conduit or tubing such as, but not limited to, flexible surgical tubing, metal mesh, vinyl-clad, conduit/tubing using quick-connect adapters and couplings, or some other similar type conduit or tubing known in the art. In addition, the electrical connection is able to carry signals to and from microprocessor 118 from and to at least one camera 102, at least one microphone 104, video modulator 108, boost converter 110, pre-amplifier 112, power amplifier 114, antenna 116, battery pack 106, solar blanket 120 and any other electrical components in the system.

Microprocessor 118 controls at least one camera 102, at least one microphone 104, video modulator 108, boost converter 110, pre-amplifier 112, power amplifier 114, antenna 116, battery pack 106, and solar blanket 120, and ensures the system is functioning properly. In one embodiment, microprocessor 118 can be controlled wirelessly to operate the components of the system by controlling various actions, examples of which include, but are not limited to, camera on/off, pan/tilt/zoom, transmit power, audio level, lens wiper, IR “headlight” activation, visible locator lamp, output power of power amplifier 114, channel selection or other variable settings on video modulator 108, and remote release of the system. Wireless feedback from microprocessor 118 to a base station may include, but is not limited to, information such as battery level, transmitter power, subject motion, command acknowledge, locator beacon signal, and/or other desired information about the system or animal. In one embodiment, microprocessor 118 allows for selective monitoring based on characteristics such as subject motion, ambient light, and/or preset intervals. Microprocessor 118 is located in housing 124.

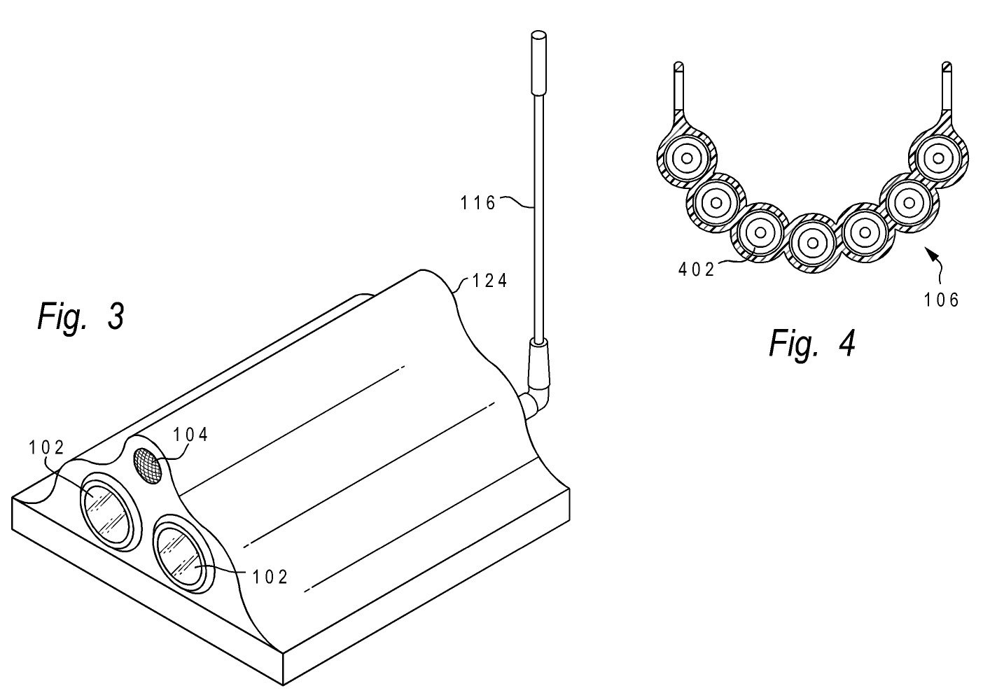

Housing 124 is comprised of plastic, aluminum, rubber coated aluminum, ceramic, carbon-fiber, polyethylene, ABS, stainless steel, anodized aluminum, polyurethane coated 1000 dernier Cordura, and other similar material that is lightweight, durable, water resistant, flexible, and moldable. While housing 124 may have only at least a portion of at least one camera 102, more than at least one camera 102 may be provided for alternative image recording in infrared bandwidth or other desired characteristic (wide angle lens, color filtered lens, and the like) or may serve as a backup camera. As shown in FIG. 3, housing 124 contains at least a portion of at least one camera 102, at least a portion of at least one microphone 104, and at least a portion of antenna 116. Also contained with housing 124, but not shown, is modulator 108, boost converter 110, pre-amplifier 112, power amplifier 114, and microprocessor 118. In the preferred embodiment, housing 124 is secured to an animal's head in such a manner that would allow the animal to function unencumbered in its natural habitat. Preferably, the animal would be sedated or tranquilized while the housing was being secured to the animal.

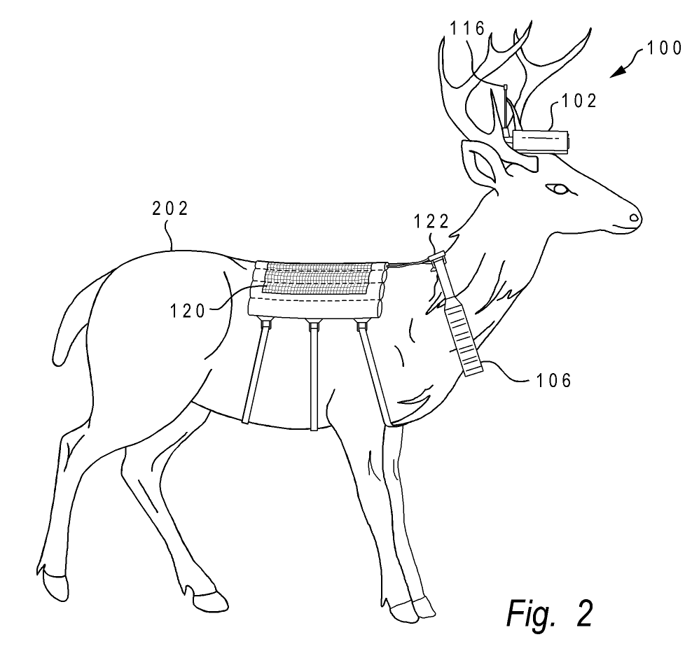

For example, if the system were used on a deer, as shown in FIG. 2, then while the deer was tranquilized, housing 124 would be mounted between the deer's antlers using an adhesive, such as an epoxy, between the base of housing 124 and at the top of the deer's head. A quick release base plate or bridle cinch system may also be used to secure housing 124 to the animal's head.

Housing 124 is stabilized using pre-perforated metal strips wherein the metal strips would be located between the deer's antlers and housing 124. Small holes are drilled through the antlers and screws are inserted through housing 124, the metal strips, and into the antlers. Other ruminant animals with antlers may use the same or similar securing arrangement for housing 124 as described here for the deer. For an animal other than a deer or an animal without antlers, housing 124 is secured in such a manner that allows the animal to function in its natural habitat and such securing means would be obvious to those skilled in the art. For example, to secure housing 124 on an animal without antlers, epoxy and/or a bridle cinch may be used or a non-evasive hood may be placed on the animal.

After housing 124 is mounted on the animal, at least one camera's 102 field of view is adjusted so the camera captures what the animal sees or is looking at. Preferably the field of view includes the tip of the animal's nose and horizon for perspective.

In one embodiment, at least one camera 102 is a color camera and preferably is a low voltage color bullet-type camera having a high resolution CCD imager greater than 100 lines, preferably at least 300 lines, a field of view greater than 10 degrees, preferably at least 50 degrees. Further, camera 102 is weatherproof, relatively small in size, and has a relatively low current consumption. In another embodiment, at least one camera 102 includes an infrared (IR) camera to capture images at night wherein the IR camera is a low voltage IR bullet-style camera having integrated LEDs for nighttime operation, a high resolution CCD imager greater than 100 lines, preferably at least 300 lines, a field of view greater than 10 degrees, preferably at least 50 degree, is weatherproof, relatively small in size, and has a relatively low current consumption.

Still more preferably, at least one camera 102 is a combination color/IR low voltage bullet camera having color and IR capability in a single unit, integrated LEDs for nighttime operation, a high resolution CCD imager greater than 300 lines, field of view greater than 60 degrees, is weatherproof, relatively small in size, and has a relatively low current consumption in color and IR modes. An example of a suitable camera includes, but is not limited to model CW134085CI manufactured by Yan Laboratory Electric Science & Technology (USA) LLC. located in Denver, Colorada.

Proximate to at least one camera 102 is microphone 104. Microphone 104 can detect a sound and transmit the acoustical energy as electrical energy for use by the system. Microphone 104 is weatherproof, relatively small in size, and has a relatively low current consumption. Microphone 104 and at least one camera 102 capture video and sound and transmit the signal to video modulator 108.

Video modulator 108 modulates the signal received by microphone 104 and at least one camera 102. Preferably video modulator 108 has a supply voltage of less than about 5 VDC, current consumption of about 50 mA, relatively low external component count, channel 21-69 UHF operation, no external varicaps diodes/inductor or tuned components, VHF range possible by internal dividers, boosted TV out level, a programmable picture/sound carrier ratio such as 12 dB to 16 dB, programmable sound reference frequency, such as 31.25 kHz and 62.5 kHz, and low-power programmable modulator standby mode. An example of a suitable video modulator 108 is the Freescale video/audio UHF modulator model number MC44BS373CA manufactured by Motorola, Inc. located in Schaumburg, Ill. Video modulator 108 modulates the audio and video signal received from microphone 104 and at least one camera 102 and transmits the modulated signal to pre-amplifier 112.

Pre-amplifier 112, is a low noise amplifier suitable for mobile communications. Preferably pre-amplifier 112 has a input and output matched to 50 Ohms, a high gain, low NF, is relativley small, and has a relatively low current consumption. An example of a suitable pre-amplifier 112 is the Infineon pre-amplifier model number BGA420 manufactured by Infineon Technologies AG located in Munich, Germany. Pre-amplifier 112 prepares the modulated signal from microphone 104 and at least one camera 102 for further amplification or processing by power amplifier 114.

Power amplifier 114 is a UHF transmitter and is used to amplify the signal for increased reception. Preferably, power amplifier 114 is designed to operate using a relatively low voltage, such as about 3.5V, from a battery source and produce an output power of about 50 mW for about 200 meter reception range. An example of a suitable power amplifier 114 is model number RF2155 manufactured by RF Micro Devices, Inc located in Greensboro, N.C. or model number MV915VTx manufactured by Microvideo Limited located in Babraham England. It would be preferable if the output power of power amplifier 114 was adjustable to optimize range and current consumption. Power amplifier 114 sends the amplified signal to antenna 116.

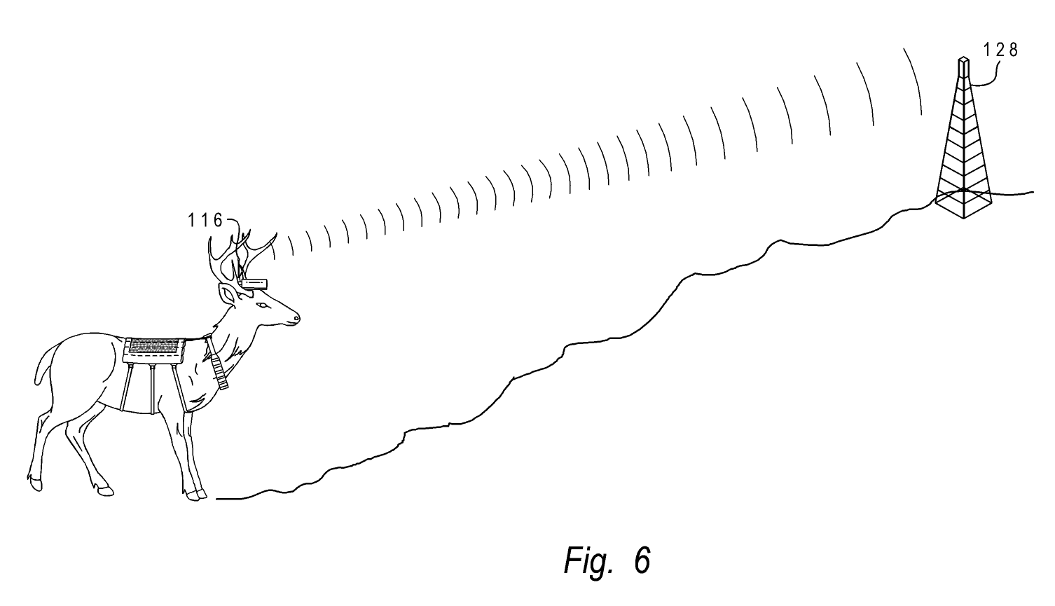

Antenna 116 is at least partially located on or in housing 124. In one embodiment, antenna 116 is contained entirely within housing 124. Preferably antenna 116 is a whip antenna. Antenna 116 transmits the amplified signal from power amplifier 114 such that the transmitted signal may be received by receiving antenna 128, as shown in FIG. 6. An example of a suitable receiving antenna is UHF antenna model 4228 manufactured by Channel Master located in Smithfield, N.C.

After the signal is received by receiving antenna 128, the signal is sent to receiving station 906 shown in FIG. 9. Receiving station 906 contains at least one computer and other components for receiving the signal sent from receiving antenna 128, processing and/or storing the signal, and transmitted the signal to another location. In one embodiment, a high-gain signal amplifier is used to amplify the signal sent to receiving station 906 from receiving antenna 128. Coaxial cable may be used to connect receiving antenna 128 to a high-gain signal amplifier such as Model 15-2507 TV/HDTV manufactured by Tandy Corporation located in Fort Worth, Tex. and the high-gain signal amplifier to receiving station 906. In another embodiment, the high-gain signal amplifier has a 3-foot output coaxial cable attached to a USB 2.0 TV tuner such as the TV Wonder manufactured by ATI Technologies Inc. located in Ontario, Canada. The USB 2.0 TV tuner is able to convert the analog signal received by the receiving antenna and convert the analog signal to digital video in MPEG 2/4 format and send the captured information to receiving station 906.

Receiving station 906 can store the signal received by receiving antenna 128 and/or send the signal to another location via the Internet, LAN, WAN, or some other network connection. Power for receiving station 906 may be supplied by an available AC source such as an electric outlet, field generator, solar panels, wind-generators, or other means known in the art for providing electrical power to a remote location.

In one embodiment, the system can monitor temperature, heart rate, respiratory rate, location using a global positioning system (GPS) or some other system for tracking, and other data relating to a subject animal and how the animal behaves in its natural environment, free of human influences. The monitoring can be achieved via an externally mounted radio telemetry device that emits signals, receivers that detect and record data, and other accessories known in the art that allowing the animal's cardiovascular, respiratory, temperature, energetics, metabolic rates, and daily activities to be monitored. The monitoring device may store the data and then wirelessly transmitted the data at predetermined intervals or the monitoring device may transmit the date in real time.

FIG. 6 shows an example of the system using direct reception of the signal sent by antenna 116 to receiving antenna 128. In this embodiment, receiving antenna 128 is shown to be within the receiving range of the signal transmitted by antenna 116. Preferably, receiving antenna 128 is located at maximum elevation to maximize reception area. In another embodiment, receiving antenna 128 is mobile thereby providing the ability to track a far ranging subject animal as it moves without having to deploy a remote monitoring device with a large transmission range, or using multiple receiving antenna or repeaters.

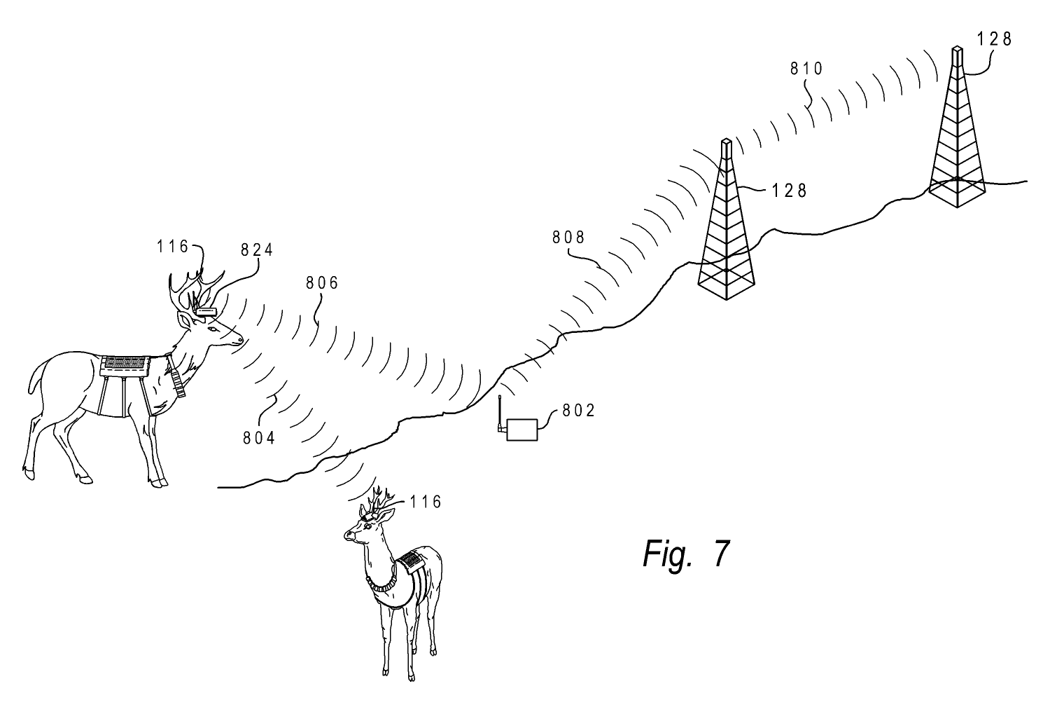

FIG. 7 shows an example of the system having at least one repeater 802. In this embodiment, repeater 802 used to receive the data transmissions from antenna 116 and then transmit the received signal to receiving antenna 128. In one embodiment, multiple repeaters 802 are used to provide the maximum coverage for an area.

Multiple repeaters 802 may be placed close enough together so that several repeaters 802 can simultaneously receive good-strength transmissions from antenna 116. To ensure that only one repeater 802 is enabled for transmitting a received signal to receiving antenna 128, each repeater 802 may contain a control unit having a wireless transceiver to transmit and/or receive various data such as signal-strength information and control signals of each repeater 802.

The wireless transceiver in repeater 802 may send signal strength data to receiving station 906 via receiving antenna 128 whereby receiving station 906 processes the received data strength signals from each repeater 802 and then sends a unique command to the repeater 802 having the best signal, and thereby enables only that repeater 802 to transmit data. Signal strength information may be regularly sent from each repeater 802 to receiving station 906 to allow rapid handover from one repeater 802 to another as the subject animal moves.

In one embodiment, at least one repeater is incorporated into housing 824. Housing 824 is identical to housing 124 except for the addition of the at least one repeater being incorporated. The at least one repeater is attached to a subject animal and can receive signals sent from an antenna 116 located on another subject animal and then transmit the signal to a second repeater 802 or to antenna 116. This is shown in FIG. 7 wherein one animal transmits a signal 804 that is received and transmitted by a repeater incorporated into housing 824. Signal 806 is sent from housing 824 to a stationary repeater 802 that transmits a signal 808 to a first antenna 128. The first antenna 128 then transmits a signal 810 to a second antenna 128 which may then send a signal to a receiving station 906. Thereby, a multitude of animals may be tracked and observed over a wide distance.

Repeater 802 may contain a field generator or charging facility such as solar panels or wind-generator to reduce the number of maintenance trips and thereby minimize human impact on the environment of the subject animal.

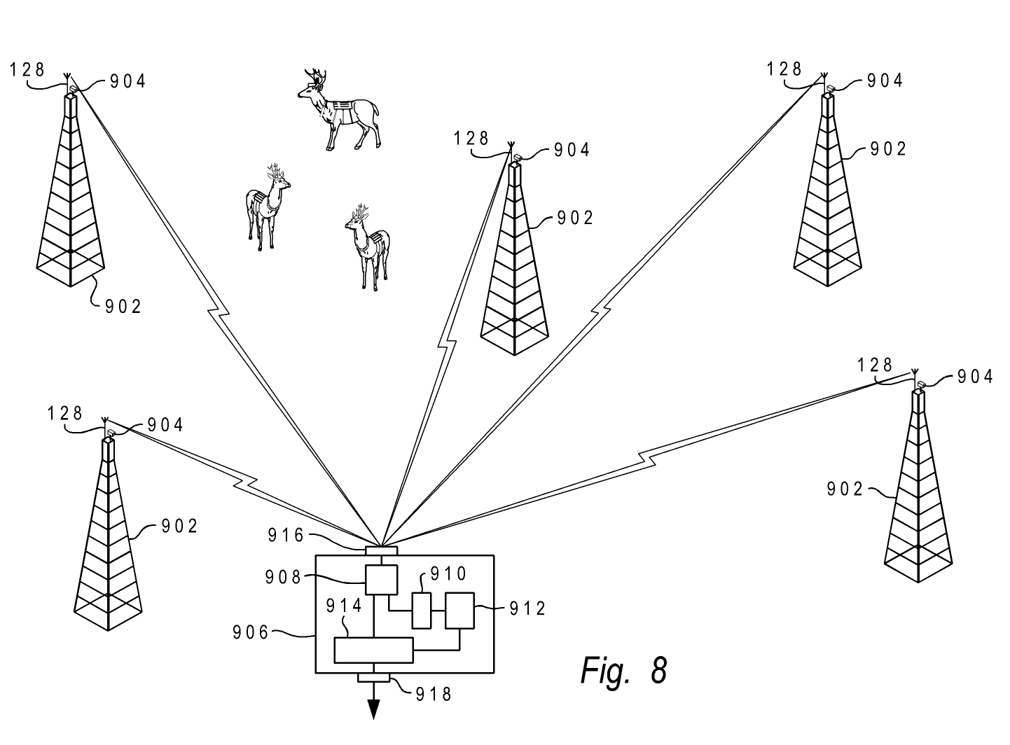

In one embodiment, shown in FIG. 8, more than one tower 902 may be located in a predetermined area to create an observation area. Each more than one tower 902 contains at least one receiving antenna 128 for receiving a signal sent by each antenna 116 in the observation area. After each receiving antenna 128 on more than one tower 902 receives a signal from antenna 116, more than one tower 902 transmits the signal to receiving station 906.

The signal sent from more than one tower 902 is received by signal receiver 916 located on receiving station 906. Signal receiver 916 transmits the received signal to splitter 908 that splits each received signal from more than one tower 902 into different signals such that each split signal represents the signal sent from each antenna 116. For example, if three animals are in the observation area and each animal has an antenna 116 that transmits a signal, then splitter 908 would split the signal received by each more than one tower 902 into three separate signals with each separate signal representing the signal sent from each of the three antennas 116 on the animal.

Each of the separate split signals are then transmitted to switch 914 and received signal strength indicator (RSSI) 910. RSSI 910 receives all of the split signals from each more than one tower 902 and determines which more than one tower 902 received the strongest signal from each antenna 116 in the observation area. For example, if there are three animals in the observation area, then a first tower 902 may be able to receive the best signal from the first animal (animal number 1), while a second tower 902 may be able to receive the best signal from the second animal (animal number 2), and a third tower 902 may be able to receive the best signal from the third animal (animal number 3).

RSSI 910 transmits the signal strength of each received signal to computer 912. Computer 912 then determines which more than one tower 902 received the best signal sent from each antenna 116 and activates switch 914 to only allow the best signal from each antenna 116 to pass to transmitter 918. After the signal is received by transmitter 918, the signal is transmitted to another location via the Internet, LAN, WAN, or some other network connection.

More than one tower 902 may also contain camera 904. Camera 904 is used to monitor the observation area and has the ability to pan, tilt, or zoom. Camera 904 can help monitor the animal and give an overview of the activity of the animal being monitored.

The present invention generally comprises a system that allows scientists, hunters, landowners and others the ability to track, monitor, and study animal movement on privately held land or for the use of government agencies on public ground. The system has the ability to operate continuously and provide full motion video and audio from the animal's perspective and current location.

It should be understood that the foregoing relates to exemplary embodiments of the invention and that modifications may be made without departing from the spirit and scope of the invention as set forth in the following claims.

What is claimed is:

1. A method of observing an animal in real time, the method comprising the steps of:
attaching an apparatus to an animal whereby the apparatus comprises:
a least one battery;
at least one camera operationally connected to the at least one battery; and
an antenna operationally connected to the at least one camera wherein the antenna is capable of transmitting a signal received from the camera;
transmitting a signal from the apparatus via the antenna; and
receiving the transmitted signal from the apparatus and processing the signal such that the animal may be observed in real time.

2. The method of claim 1 wherein the apparatus further comprises a microphone.

3. The method of claim 1 wherein the camera is a color camera.

4. The method of claim 1 wherein the camera is a combination color camera and IR camera.

5. The method of claim 2 wherein the apparatus further comprises a modulator.

6. The method of claim 5 wherein the apparatus further comprises an amplifier.

7. The method of claim 1 wherein the antenna is contained within the housing.

8. The method of claim 1 wherein after the signal is processed it is transmitted over the Internet.

9. The method of claim 1 wherein the animal is a deer or other animal, domestic or wild.

10. The method of claim 1 wherein the system contains the additional step of receiving the transmitted signal from the apparatus by a repeater and then the repeater re-transmitting the signal for processing.

11. A device for observing an animal in real time, the device comprising:
an animal observation unit comprising:
a least one battery;
at least one camera operationally connected to the at least one battery; and
an antenna operationally connected to the at least one camera wherein the antenna is capable of transmitting a signal received from the camera;
means for attaching the observation unit to an animal;
a receiving antenna for receiving the transmitted signal from the observation unit; and
a computer for processing the signal received by the receiving antenna such that the animal may be observed in real time.

12. The device of claim 1 wherein the observation unit further comprises a microphone.

13. The device of claim 1 wherein the camera is a color camera.

14. The device of claim 1 wherein the camera is a combination color camera and IR camera.

15. The device of claim 2 wherein the observation unit further comprises a modulator.

16. The device of claim 5 wherein the observation unit further comprises an amplifier.

17. The device of claim 1 wherein the antenna is contained within the housing.

18. The device of claim 1 wherein after the signal is processed it is transmitted over the Internet.

19. The device of claim 1 wherein the animal is a deer or other animal, domestic or wild.

20. The device of claim 1 further comprises a repeater disposed between the animal observation unit and the receiving antenna.
